(19) United States
(12) Patent Application Publication
(10) Pub. No.: US 2017/0314502 A1
(43) Pub. Date: Nov. 2, 2017

(54) INTERNAL COMBUSTION ENGINE

(71) Applicant: TOYOTA JIDOSHA KABUSHIKI KAISHA, Toyota-shi (JP)

(72) Inventors: Takashi SUZUKI, Susono-shi (JP); Hiroshi YAGUCHI, Susono-shi (JP); Hisashi OHKI, Numazu-shi (JP)

(73) Assignee: TOYOTA JIDOSHA KABUSHIKI KAISHA, Toyota-shi (JP)

(21) Appl. No.: 15/497,719

(22) Filed: Apr. 26, 2017

(30) Foreign Application Priority Data
Apr. 28, 2016 (JP) 2016-091461

(51) Int. Cl. F02F 1/18; F02F 3/00; F02F 7/00; F02F 1/24

(52) U.S. Cl. CPC F02F 1/18; F02F 7/0021; F02F 1/24; F02F 3/0015; F02F 2007/0041

(57) ABSTRACT

An internal combustion engine has a cylinder block and a cylinder head fixed to each other with a plurality of bolts, and a piston fitted in a cylinder bore of the cylinder block so as to be able to reciprocate. A portion of the cylinder bore having a minimum diameter in a travel range of a skirt across which the skirt travels as the piston reciprocates is located within a range facing the skirt when the piston is at a bottom dead center. A clearance between the skirt and the minimum-diameter portion has a minimum value of a clearance between the skirt and a wall surface of the cylinder bore.

### INCORPORATION BY REFERENCE

The disclosure of Japanese Patent Application No. 2016-091461 filed on Apr. 28, 2016 including the specification, drawings and abstract is incorporated herein by reference in its entirety.

### BACKGROUND

### 1. Technical Field

The present disclosure relates to a reciprocating internal combustion engine in which a piston reciprocates inside a cylinder bore.

### 2. Description of Related Art

A reciprocating internal combustion engine has a cylinder block, a cylinder head, and a piston. The cylinder block has at least one cylinder bore extending along an axis. The cylinder head is fixed to one end of the cylinder block with a plurality of bolts. The piston is fitted in the cylinder bore so as to be able to reciprocate along the axis. The piston has a skirt through which the piston can slide along a wall surface of the cylinder bore.

That the cylinder bore has a high degree of roundness over the entire range of reciprocation of the piston is an important factor in allowing smooth reciprocation of the piston inside the cylinder bore and reducing blow-by gas etc. to enhance the operation efficiency of the internal combustion engine.

International Publication No. WO 2011/152216 discloses a technique for obtaining, in advance, a predicted value of the amount of deformation that a cylinder bore undergoes as a cylinder head is fixed to one end of a cylinder block with a plurality of bolts. Thus, the cylinder bore is processed into such a shape as will become perfect round when deformation of that predicted value occurs. Compared with processing the cylinder bore without predicting the amount of deformation of the cylinder bore, this technique can increase the degree of roundness of the cylinder bore after the cylinder head is fixed to one end of the cylinder block.

### SUMMARY

In an internal combustion engine, to reduce friction between various movable members and members coming in contact therewith, these members are lubricated with engine oil supplied to the clearances between the members. For example, the piston and the wall surface of the cylinder bore are lubricated as engine oil is supplied from a crank chamber to the clearance between the piston and the wall surface of the cylinder bore, either by oil jet lubrication or by splash lubrication through the crankshaft.

Although, the cylinder bore has a high degree of roundness, when the clearance between the piston skirt and the wall surface of the cylinder bore is small, the amount of engine oil that can be present in that clearance is small. Accordingly, a high degree of friction may occur between the skirt and the wall surface of the cylinder bore. This may result in a large friction loss. Conversely, when the clearance between the skirt and the wall surface of the cylinder bore is large, the amount of engine oil that can be present in that clearance is large. Accordingly, a large amount of engine oil may move toward the combustion chamber as the piston reciprocates. Having moved to the combustion chamber, the engine oil is gasified by evaporation, combustion, etc. and discharged to the outside of the internal combustion engine along with exhaust gas. Thus, the larger the amount of engine oil moving to the combustion chamber, the larger the engine oil consumption.

The present disclosure provides an internal combustion engine that is improved so as to reduce the engine oil consumption while avoiding a high degree of friction between the piston skirt and the wall surface of the cylinder bore.

One aspect of the present disclosure is an internal combustion engine including a cylinder block, a cylinder head, and a piston. The cylinder block has at least one cylinder bore. The at least one cylinder bore extends along an axis of the cylinder bore. The cylinder head is fixed to a first end of the cylinder block with a plurality of bolts. The piston is configured to reciprocate along the axis. The piston is housed in the cylinder bore. The piston includes a skirt that can slide along a wall surface of the cylinder bore. The cylinder bore includes a first portion within a first range. The first portion is a portion at which a diameter of the cylinder bore is minimum in a second range of the cylinder bore. The second range is a range across which the skirt travels as the piston reciprocates. The first range is a range in an axial direction of the cylinder bore facing the skirt when the piston is at a bottom dead center. A clearance in a radial direction of the cylinder bore between the skirt and the first portion when the piston is located at the bottom dead center has a minimum value of a clearance in the radial direction between the skirt and the wall surface of the cylinder bore in the second range.

According to the above configuration, the minimum-diameter portion (first portion) of the cylinder bore in the travel range (second range) of the skirt across which the skirt travels as the piston reciprocates faces the skirt when the piston is at the bottom dead center. Moreover, the clearance between the skirt and the minimum-diameter portion when the piston is at the bottom dead center is the minimum clearance between the skirt and the wall surface of the cylinder bore in the travel range of the skirt.

Thus, the amount of engine oil supplied from the crank chamber to the clearance between the skirt and the wall surface of the cylinder bore when the piston is at or in the vicinity of the bottom dead center can be reduced. Moreover, the amount of engine oil moving by adhering to a radially outer surface of the skirt during a compression stroke of the piston can be reduced. It is therefore possible to reduce the amount of engine oil moving to the combustion chamber via the clearance between the skirt and the wall surface of the cylinder bore as the piston reciprocates, and to thereby reduce the engine oil consumption.

Moreover, during a compression stroke of the piston, the clearance between the skirt and the wall surface of the cylinder bore is larger than the minimum value, and also during an expansion stroke of the piston, this clearance is kept at a value larger than the minimum value. Thus, it is possible to avoid a high degree of friction between the skirt and the wall surface of the cylinder bore when the piston is in a range of stroke other than at and in the vicinity of the bottom dead center.

In the present application, the “skirt” is a portion that has a larger outer diameter than a small-diameter portion where a piston ring is disposed, is located farther from the cylinder head than the small-diameter portion is, and can slide along the wall surface of the cylinder bore when the piston reciprocates.

In the above internal combustion engine, the cylinder block may include the first end and a second end. The skirt may include a third end and a fourth end. The third end may be an end of the skirt located closer to the first end of the cylinder block when the piston is located at the bottom dead center. The fourth end may be an end of the skirt located farther from the first end of the cylinder block when the piston is at the bottom dead center. When the piston is at the bottom dead center, the fourth end may be located at one of a position at the same position in the axial direction as the second end and a position closer to the first end than the same position as the second end. When the piston is at the bottom dead center, the first portion may be located closer to the second end of the cylinder block than the third end is.

According to the above configuration, also when the piston is at the bottom dead center, the entire skirt faces the wall surface of the cylinder bore, so that the skirt is not exposed to the crank chamber. Thus, no large amount of engine oil is directly supplied to the surface of the skirt in the crank chamber. Moreover, when the piston is at the bottom dead center, the clearance between the skirt and the wall surface of the cylinder bore is minimum at the other end of the cylinder block, i.e., the end (second end) closer to the crank chamber, relative to the clearance at the end (third end) of the skirt closer to the one end of the cylinder block. Thus, it is possible to reduce the amount of engine oil supplied to the clearance between the skirt and the wall surface of the cylinder bore, on the side of the one end from the position with the minimum clearance, when the piston is at the bottom dead center.

In the above internal combustion engine, the first portion may be located at a position facing the fourth end of the skirt when the piston is at the bottom dead center.

According to the above configuration, the clearance between the skirt and the wall surface of the cylinder bore when the piston is at the bottom dead center is minimum at an axial position of the end of the skirt farther from the one end, i.e., of the end (fourth end) of the skirt closer to the crank chamber. Thus, the amount of engine oil supplied from the crank chamber to the clearance between the skirt and the wall surface of the cylinder bore when the piston is located at and in the vicinity of the bottom dead center can be effectively reduced.

In the above internal combustion engine, the cylinder bore may include a fifth end. The fifth end may be an end of the cylinder bore located closer to the second end of the cylinder block. The fourth end of the skirt when the piston is at the bottom dead center may be located on the opposite side of the fifth end from the first end. The fifth end of the cylinder bore may be a part of the first portion.

According to the above configuration, when the piston is at the bottom dead center, the end (fourth end) of the skirt farther from the one end is exposed to the crank chamber, so that the engine oil is directly supplied to a surface of the exposed portion of the skirt. However, the end (fifth end) of the cylinder bore closer to the other end of the cylinder block constitutes the minimum-diameter portion (first portion), where the clearance between the skirt and the wall surface of the cylinder bore has a minimum value. Thus, it is possible to reduce the amount of engine oil supplied from the crank chamber to the clearance between the skirt and the wall surface of the cylinder bore, on the side of the one end from the minimum-diameter portion, when the piston is at the bottom dead center. Moreover, it is possible to scrape off engine oil adhering to the radially outer surface of the exposed portion of the skirt by the minimum-diameter portion when the piston moves from the bottom dead center toward a top dead center.

In the above internal combustion engine, when seen in a section in a radial direction passing through the axis, the wall surface of the cylinder bore may has a curved surface adjacent to the first portion and may be located closer to the first end than the first portion is. The curved surface may be more convex toward the axis than a conical surface connecting the first portion and a second portion to each other. The second portion may be located closer to the first end than the first portion is in the cylinder bore. The second portion may have a diameter larger than the minimum diameter.

According to the above configuration, compared with if the wall surface of the cylinder bore forms a conical shape or a curved surface convex in a direction away from the axis, the clearance between the skirt and the wall surface of the cylinder bore on the side of the one end from the minimum-diameter portion can be reduced. Thus, it is possible to reduce the amount of engine oil present between the skirt and the wall surface of the cylinder bore in the region adjacent to the minimum-diameter portion and located closer to the one end than the minimum-diameter portion is.

Moreover, compared with if the wall surface of the cylinder bore forms a conical shape or a curved surface convex in a direction away from the axis, the clearance between the end of the skirt farther from the one end and the wall surface of the cylinder bore when the piston moves off the bottom dead center toward the top dead center can be reduced. Thus, it is possible to reduce the amount of engine oil supplied from the crank chamber to the clearance between the skirt and the wall surface of the cylinder bore when the piston moves off the bottom dead center toward the top dead center.

In the above internal combustion engine, the first portion may have a constant diameter. The first portion may be a portion in a cylindrical region of the cylinder bore extending along the axis in the cylinder bore.

According to the above configuration, compared with if the minimum-diameter portion does not extend with a constant diameter along the axis, a range of stroke of the piston in which the clearance in the radial direction between the skirt and the wall surface of the cylinder bore is kept at a minimum value can be widened. Thus, compared with if the minimum-diameter portion does not extend with a constant diameter along the axis, the amount of engine oil supplied from the crank chamber to the clearance between the skirt and the wall surface of the cylinder bore when the piston is at or in the vicinity of the bottom dead center can be reduced.

In particular, compared with when the diameter of the cylinder bore at the end opposite from the one end is larger than the minimum diameter, when the cylindrical region extends to the end of the cylinder bore opposite from the one end, the amount of engine oil adhering to the radially outer surface of the skirt when the piston is at the bottom dead center can be reduced. Thus, the amount of engine oil moving upward by adhering to the surface of the skirt during a compression stroke of the piston can be effectively reduced.

In the above internal combustion engine, the diameter of a part of the cylinder bore facing the skirt when the piston is at the top dead center may be smaller toward the first end.

The piston supports a compression ring and an oil ring in a region that is located closer to the one end than the skirt is and has a smaller diameter than the skirt. These rings come in sliding contact with the wall surface of the cylinder bore. According to the above configuration, the diameter of the cylinder bore in the region facing the skirt when the piston is at the top dead center is smaller toward the one end. Accordingly, the interval between the compression ring and the wall surface of the cylinder bore becomes smaller and a gas flow path becomes narrower as the piston comes closer to the top dead center. Thus, the amount of blow-by gas generated when the piston is at or in the vicinity of the top dead center can be reduced.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a schematic configurational view showing a first embodiment of an internal combustion engine according to the present disclosure;

FIG. 2 is a front view of a piston shown in FIG. 1, as seen from a direction perpendicular to an axis;

FIG. 3 is a bottom view of the piston shown in FIG. 2, as seen from a crankshaft along the axis;

FIG. 4 is a partially enlarged view showing the first embodiment in a longitudinal section;

FIG. 5 is a partially enlarged view showing main parts of the first embodiment in a longitudinal section;

FIG. 6 is a view illustrating various internal combustion engines that are different from one another in diameter of a cylinder bore at an upper part, a middle part, and a lower part along an axis;

FIG. 7 is a partially enlarged view showing, in a longitudinal section, main parts of a second embodiment of the internal combustion engine according to the present disclosure;

FIG. 8 is a partially enlarged view showing, in a longitudinal section, main parts of a third embodiment of the internal combustion engine according to the present disclosure;

FIG. 9 is a partially enlarged view showing, in a longitudinal section, main parts of a fourth embodiment of the internal combustion engine according to the present disclosure; and

FIG. 10 is a partially enlarged view showing, in a longitudinal section, main parts of a fifth embodiment of the internal combustion engine according to the present disclosure.

### DETAILED DESCRIPTION OF EMBODIMENTS

Preferred embodiments of the present disclosure will be described in detail below with reference to the accompanying drawings.

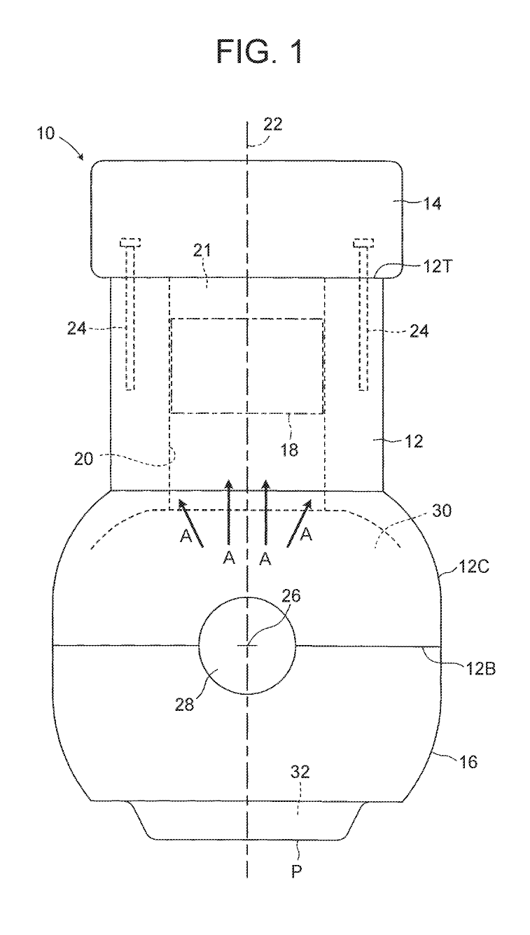

FIG. 1 is an overall view showing an internal combustion engine 10 according to a first embodiment of the present disclosure. The internal combustion engine 10 has a cylinder block 12, a cylinder head 14, a lower case 16, and a piston 18. The cylinder block 12 has a number of cylinder bores 20 corresponding to a number of cylinders that are arrayed in a direction perpendicular to the sheet plane of FIG. 1. In the cylinder block 12, each cylinder bore 20 extends along an axis 22. The cylinder block 12 and the cylinder head 14 are provided with a cooling water passage. In FIG. 1, this cooling water passage is not shown. In FIG. 1, the cylinder head 14 is fixed to one end 12T (one example of the “first end”) of the cylinder block 12 with the bolts 24, at a plurality of positions on both sides of the cylinder bores 20 at intervals in the direction perpendicular to the sheet plane of FIG. 1. Hereinafter, one end of a member on the upper side as seen in FIG. 1 etc. will be referred to as an upper end, and the other end on the lower side as seen in FIG. 1 etc. will be referred to as a lower end. An upward direction and the upper side as seen in FIG. 1 etc. will be referred to simply as the upward direction and the upper side, and a downward direction and the lower side as seen in FIG. 1 etc. will be referred to simply as the downward direction and the lower side.

The lower case 16 is fixed to a lower end 12B (one example of the “second end”) of a crankcase 12C of the cylinder block 12 with a plurality of bolts (not shown in FIG. 1). The crankcase 12C and the lower case 16 work in conjunction to support a crankshaft 28 so as to be rotatable around a rotational axis 26 perpendicular to the axis 22. The crankcase 12C and the lower case 16 a crank chamber 30. The piston 18 is fitted in the cylinder bore 20 so as to be able to reciprocate along the axis 22. In conjunction with the cylinder block 12 and the cylinder head 14, the piston 18 forms a combustion chamber 21. A reciprocation of the piston 18 is transmitted to the crankshaft 28 through a piston pin and a connecting rod (neither is shown in FIG. 1), and is converted into a rotary motion of the crankshaft 28 by these members working in conjunction with each other.

A lower part of the lower case 16 forms an oil pan P where engine oil 32 is stored. The engine oil 32 is supplied from the crank chamber 30 to a lower end of the cylinder bore 20 and to an inside of the piston 18, either by splash lubrication through the crankshaft 28 or by oil jet lubrication through a force-feed lubrication device (not shown in FIG. 1). Supply paths of the engine oil 32 are indicated by arrows A in a simplified manner. The engine oil 32 supplied to the lower end of the cylinder bore 20 lubricates the cylinder block 12 and the piston 18 by being present therebetween. The engine oil 32 is circulated and supplied by the force-feed lubrication device to other moving components, including a camshaft, an intake valve, and an exhaust valve, to lubricate these components.

Part of the engine oil 32 lubricating the cylinder block 12 and the piston 18 moves to the combustion chamber 21 as the piston 18 reciprocates. Having moved to the combustion chamber 21, the engine oil 32 is gasified by evaporation and combustion and discharged to an outside of the internal combustion engine 10 along with exhaust gas. Thus, to reduce the consumption of the engine oil 32 lubricating the cylinder block 12 and the piston 18, it is effective to ensure that no excessive amount of engine oil 32 is supplied from the crank chamber 30 and present between the cylinder block 12 and the piston 18.

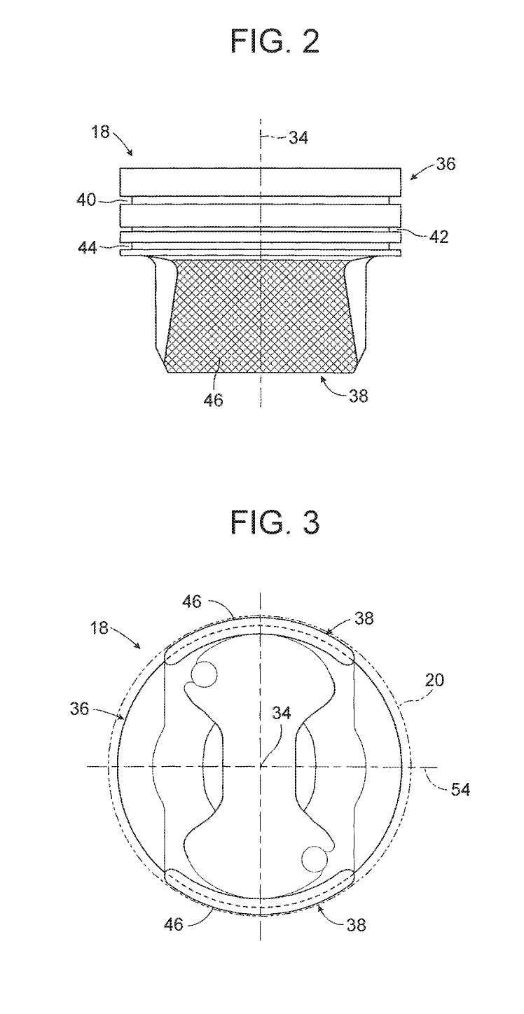

As shown in FIG. 2 and FIG. 3, the piston 18 has a columnar part 36 extending along an axis 34, and two skirts 38 formed integrally with the columnar part 36. When seen from the lower side along the axis 34, the skirts 38 are disposed one on each side of an axis 54 of the piston pin (not shown), at an interval in a radial direction relative to the axis 34. At least in the vicinity of the columnar part 36, the skirt 38 may extend along the entire circumference around the axis 34.

The columnar part 36 has two ring grooves 40, 42 in which compression rings (not shown) are disposed, and one ring groove 44 in which an oil ring (not shown) is disposed. The skirt 38 extends along the axis 34 so as to form an arc-shaped plate around the axis 34. The skirt 38 has a larger outer diameter than the columnar part 36, and a principal part 46 (cross-hatched region) of an outer surface of the skirt 38 that slides along the wall surface of the cylinder bore 20 has been treated to reduce friction. The structure described so far is common for all the embodiments. The internal combustion engine of each embodiment may be either a gasoline engine or a diesel engine.

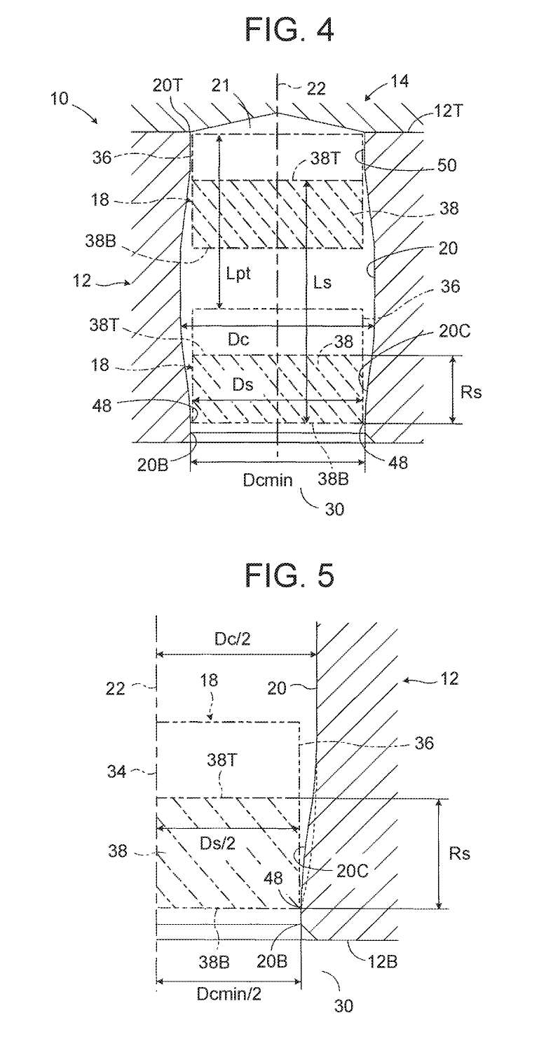

When seen in a section in a radial direction passing through the axis 22, the cylinder bore 20 in the first embodiment has the shape as shown in FIG. 4 and FIG. 5. This shape and other shapes, to be described later, of the cylinder bore 20 may be formed by honing, for example, that is performed with the cylinder block 12 fixed with bolts to a jig resembling the cylinder head 14 to finish the wall surface of the cylinder bore 20 smooth.

In FIG. 4 and FIG. 5, the one-dot dashed lines and the two-dot dashed lines schematically show positions of the piston 18 at a top dead center and a bottom dead center, respectively, and the regions hatched with the one-dot dashed lines and the two-dot dashed lines show the extent of the skirt 38. An arrow Lpt indicates a travel range of an upper end of the piston 18 across which the upper end travels as the piston 18 reciprocates. An arrow Ls indicates a travel range of the skirt 38 across which the skirt 38 travels as the piston 18 reciprocates.

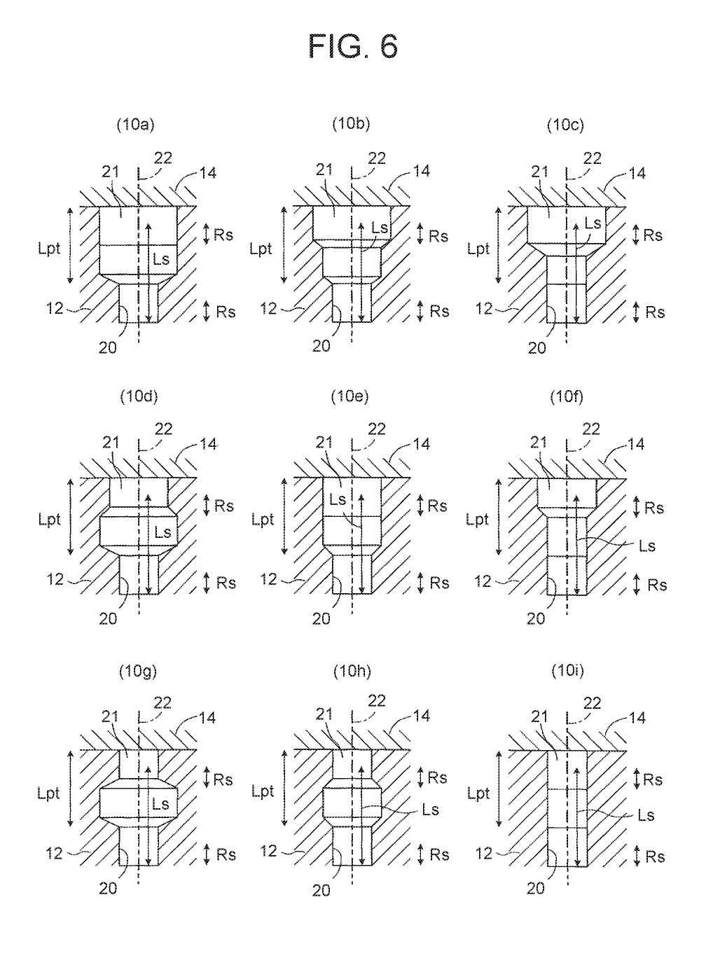

In the state shown in FIG. 4 where the cylinder head 14 is fixed to the one end 12T of the cylinder block 12 with the bolts 24, the cylinder bore 20 has a cross-sectional shape that is substantially perfect round around the axis 22 at any point from an upper end 20T to a lower end 20B of the cylinder bore 20. In FIG. 4 and FIG. 5, differences in diameter are shown in an exaggerated manner to clarify the dimensional relation of the diameters at portions of the cylinder bore 20. The same applies to FIG. 6 and the subsequent drawings.

As shown in FIG. 4 and FIG. 5, the cylinder bore 20 has a portion (one example of the “first portion”) 48 with a minimum diameter in the travel range Ls of the skirt 38. On the upper side from the minimum-diameter portion 48, i.e., the side of the upper end 12T of the cylinder block 12, in the travel range Ls of the skirt 38, a diameter Dc of the cylinder bore 20 is larger than a minimum diameter Dcmin that is the diameter of the minimum-diameter portion 48. The actual difference between the maximum value of the diameter Dc and the minimum diameter Dcmin of the cylinder bore 20 may be approximately 0.015 to 0.2 mm. The same applies to the other embodiments to be described later.

In the first embodiment, a lower end (one example of the “fourth end”) 38B of the skirt 38 when the piston 18 is at the bottom dead center is located slightly above the lower end (one example of the “fifth end”) 20B of the cylinder bore 20. The minimum-diameter portion 48 is provided at an axial position facing the lower end 38B of the skirt 38 when the piston 18 is at the bottom dead center. Thus, the minimum-diameter portion 48 is located within a range Rs facing the region of the skirt 38 from an upper end (one example of the “third end”) 38T to the lower end 38B when the piston 18 is at the bottom dead center. As shown in FIG. 4 and FIG. 5, an outer diameter Ds of the skirt 38 is substantially constant from the upper end 38T to the lower end 38B.

Thus, a clearance in the radial direction between the skirt 38 and the wall surface of the cylinder bore 20, (Dc−Ds)/2, is minimum at the lower end 38B of the skirt 38 at (Dcmin−Ds)/2. The diameter Dc of the cylinder bore 20 in the region from the position facing the lower end 38B to the lower end 20B has a constant value of the minimum diameter Dcmin. The diameter Dc in this region may be larger toward the lower end 20B, or conversely may be smaller toward the lower end 20B.

When seen in the sections shown in FIG. 4 and FIG. 5, the wall surface of the cylinder bore 20 has a curved surface 20C in a region adjacent to the minimum-diameter portion 48 and located on the upper side of the minimum-diameter portion 48. The curved surface 20C is more convex toward the axis 22 than a conical surface connecting the minimum-diameter portion 48 and a portion (one example of the “second portion”) that is located closer to the upper end 12T than the minimum-diameter portion is and has a diameter larger than the minimum diameter. Thus, an inclination angle of the curved surface 20C relative to the axis 22 is smaller toward the minimum-diameter portion 48, i.e., smaller downward.

In the first embodiment, the diameter Dc of the cylinder bore 20 in the region facing the skirt 38 when the piston 18 is at the top dead center is smaller toward the upper end 12T of the cylinder block 12. The diameter Dc of the cylinder bore 20 in a region on the upper side of the upper end 38T of the skirt 38 when the piston 18 is at the top dead center is constant. This region is region at an upper-end small-diameter portion 50 of the cylinder bore 20. The diameter Dc of the upper-end small-diameter portion 50 is preferably equal to or larger than the diameter Dcmin of the minimum-diameter portion 48, but may be smaller than the diameter Dcmin. The shape of the region of the cylinder bore 20 near the upper end 12T is the same in the other embodiments to be described later.

Next, experimentally-confirmed advantages and disadvantages of various internal combustion engines 10a to 10i that are different from one another in diameter Dc of the cylinder bore 20 at an upper part, a middle part, and a lower part along the axis 22 as shown in FIG. 6 will be described. In FIG. 6 and Table 1 to be described later, “Large” represents a diameter set to be large so as to reduce friction between the piston 18 and the wall surface of the cylinder bore 20. “Small” represents a diameter set to be as small as possible without causing excessive friction between the piston 18 and the wall surface of the cylinder bore 20, and “Medium” represents a diameter between “Large” and “Small.”

The diameters Dc of the cylinder bore 20 of the internal combustion engines 10a to 10i at the upper part, the middle part, and the lower part are as shown in FIG. 6 and Table 1 below. The item “BBG/NV” for evaluation of advantages and disadvantages in Table 1 represents blow-by gas and vibration noise. For BBG/NV, a smaller amount of blow-by gas and lower vibration noise are evaluated as higher performance. “Friction” represents friction between the piston 18 and the wall surface of the cylinder bore 20. A lower degree of friction is evaluated as higher performance. “Oil” represents the engine oil consumption. A smaller engine oil consumption is evaluated as higher performance. “Overall” represents an overall rating based on these evaluation items. The double circle means a very good rating. The single circle means a good rating. The triangle means a median rating. The cross means a poor rating. As the diameter Dc at the lower part is small in all the internal combustion engines, all the engines are rated good in “Oil.”

TABLE 1

| | Diameter Dc | | | | | | |
|---|---|---|---|---|---|---|---|
| | Upper | Middle | Lower | Advantages and Disadvantages | | | |
| No. | Part | Part | Part | BBG/NV | Friction | Oil | Overall |
| 10a | Large | Large | Small | X | ◯ | ◯ | ◯ |
| 10b | Large | Medium | Small | X | Δ | ◯ | Δ |
| 10c | Large | Small | Small | X | X | ◯ | Δ |
| 10d | Medium | Large | Small | Δ | Δ | ◯ | ◯ |
| 10e | Medium | Medium | Small | Δ | X | ◯ | Δ |
| 10f | Medium | Small | Small | Δ | X | ◯ | Δ |
| 10g | Small | Large | Small | ◯ | Δ | ◯ | ⊚ |
| 10h | Small | Medium | Small | ◯ | X | ◯ | ◯ |
| 10i | Small | Small | Small | ◯ | X | ◯ | ◯ |

In the internal combustion engine 10a, the diameter Dc is large at the upper part and the middle part. While the performance in terms of friction is good, the performance in terms of blow-by gas and vibration noise is poor. The overall rating is good. In the internal combustion engine 10b, the diameter Dc is large at the upper part and medium at the middle part. The performance in terms of friction is median, and the performance in terms of blow-by gas and vibration noise is poor. Thus, the overall rating is median.

In the internal combustion engine 10c, the diameter Dc is large at the upper part and small at the middle part. The performance is poor in terms of both friction and blow-by gas and vibration noise. Thus, the overall rating is median. In the internal combustion engine 10d, the diameter Dc is medium at the upper part and large at the middle part. The performance is median in terms of both friction and blow-by gas and vibration noise. Thus, the overall rating is good.

In the internal combustion engine 10e, the diameter Dc is medium at the upper part and the middle part, and in the internal combustion engine 10f, the diameter Dc is medium at the upper part and small at the middle part. The performance of the internal combustion engines 10e, 10f in terms of blow-by gas and vibration noise is median, but the performance in terms of friction is poor. Thus, the overall rating is median.

In the internal combustion engine 10h, the diameter Dc is small at the upper part and medium at the middle part, and in the internal combustion engine 10i, the diameter Dc is small at the upper part and the middle part. The performance of the internal combustion engines 10h, 10i in terms of blow-by gas and vibration noise is good, but the performance in terms of friction is poor. Thus, the overall rating is good.

Unlike these internal combustion engines, in the internal combustion engine 10g configured according to the present disclosure, the diameter Dc is small at the upper part and large at the middle part. The performance of the internal combustion engine 10g in terms of blow-by gas and vibration noise is good, and the performance in terms of friction is median. Thus, rated very good overall, the internal combustion engine 10g is superior in performance to all the other internal combustion engines described above.

As described above, the internal combustion engine 10 of the first embodiment has a structure belonging to the basic structure of the internal combustion engine 10g. According to the first embodiment, therefore, it is possible to secure good performance in terms of blow-by gas and vibration noise, as well as to reduce the consumption of the engine oil 32 while preventing excessive friction between the piston 18 and the wall surface of the cylinder bore 20. These basic advantages can also be achieved in the second to fifth embodiments to be described later.

In particular, according to the first embodiment, the minimum-diameter portion 48 of the cylinder bore 20 faces the lower end 38B of the skirt 38 when the piston 18 is at the bottom dead center, and the region upward from the minimum-diameter portion 48 has a diameter Dc larger than the diameter Dcmin of the minimum-diameter portion 48. Thus, compared with the structure in which the minimum-diameter portion 48 reaches a range upward from the lower end 38B (e.g., the second embodiment to be described later), friction between the cylinder bore 20 and the skirt 38 when the piston 18 is in the vicinity of the bottom dead center can be reduced.

Moreover, compared with the structure in which the minimum-diameter portion 48 faces a region upward from the lower end 38B of the skirt 38, and a region downward from the minimum-diameter portion 48 has a diameter Dc larger than the minimum diameter Dcmin (e.g., the third embodiment to be described later), the amount of engine oil present between the lower end 38B and the vicinity thereof and the wall surface of the cylinder bore 20 when the piston 18 is at or in the vicinity of the bottom dead center can be reduced.

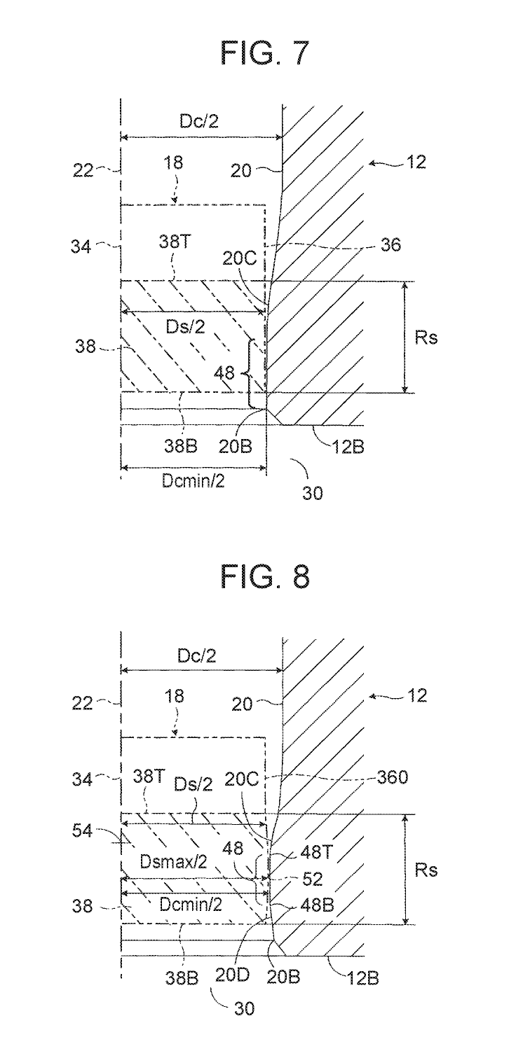

FIG. 7 shows the internal combustion engine 10 according to the second embodiment of the present disclosure. In FIG. 7, the same members as those shown in FIG. 4 and FIG. 5 are denoted by the same reference signs as in FIG. 4 and FIG. 5. The same applies to the other embodiments to be described later.

In the second embodiment, the minimum-diameter portion 48 of the cylinder bore 20 ranges from a position facing an intermediate portion of the skirt 38 between the upper end 38T and the lower end 38B when the piston 18 is at the bottom dead center, to the lower end 20B of the cylinder bore 20. In this range of the minimum-diameter portion, the wall surface of the cylinder bore 20 has a cylindrical region having a constant diameter Dmin and extending along the axis 22. Thus, the clearance in the radial direction between the skirt 38 and the wall surface of the cylinder bore 20, (Dc−Ds)/2, is minimum in this range of the minimum-diameter portion 48 at (Dcmin−Ds)/2.

The length of the curved surface 20C of the cylinder bore 20 in a direction along the axis 22 is smaller than the corresponding length in the first embodiment. Alternatively, the length of a maximum-diameter region of the cylinder bore 20 in the axial direction may be made smaller than the corresponding length in the first embodiment so that the length of the curved surface 20C becomes equal to the corresponding length in the first embodiment. The configuration of the second embodiment is otherwise the same as that of the first embodiment.

According to the second embodiment, compared with if the minimum-diameter portion 48 does not extend with a constant diameter along the axis 22, a range of stroke of the piston 18 in which the clearance in the radial direction between the skirt 38 and the wall surface of the cylinder bore 20 is kept at the minimum value (Dcmin−Ds)/2 can be widened. Thus, compared with the first embodiment, the second embodiment can effectively reduce the amount of engine oil supplied from the crank chamber 30 beyond the minimum-diameter portion 48 to the clearance between the skirt 38 and the wall surface of the cylinder bore 20, not only when the piston 18 is at the bottom dead center, but also when the piston 18 is in the vicinity of the bottom dead center. This advantage can also be achieved in the third and fourth embodiments to be described later.

In the third embodiment shown in FIG. 8, the skirt 38 of the piston 18 has a barrel shape, and a maximum-diameter portion 52 of the skirt 38 is located closer to the lower end 38B than the axis 54 of the piston pin (not shown in FIG. 8) is. A diameter Dsmax of the maximum-diameter portion 52 is smaller than the diameter Dcmin of the minimum-diameter portion 48 of the cylinder bore 20. The minimum-diameter portion 48 is a region facing the maximum-diameter portion 52 and regions on the upper and lower sides thereof of the skirt 38 when the piston 18 is at the bottom dead center. An upper end 48T of the minimum-diameter portion 48 is located at an axial position between the upper end 38T and the maximum-diameter portion 52 of the skirt 38, while a lower end 48B of the minimum-diameter portion 48 is located at an axial position between the lower end 38B and the maximum-diameter portion 52 of the skirt 38.

The diameter Dc of the minimum-diameter portion 48 has a constant value of the minimum diameter Dmin from the upper end 48T to the lower end 48B. Thus, the clearance between the skirt 38 and the wall surface of the cylinder bore 20, (Dc−Ds)/2, is minimum at the maximum-diameter portion 52 at (Dcmin−Dsmax)/2. In the embodiment shown in FIG. 8, the diameter Dc of the cylinder bore 20 downward from the lower end 48B is larger toward the lower end 20B. However, the range of the minimum-diameter portion 48 may be extended at least to a position facing the lower end 38B of the skirt 38. The configuration of the third embodiment is otherwise the same as that of the first embodiment.

According to the third embodiment, in the internal combustion engine 10 in which the skirt 38 of the piston 18 has a barrel shape, the clearance between the skirt 38 and the wall surface of the cylinder bore 20, (Dc−Ds)/2, can be minimized to the minimum value (Dcmin−Dsmax)/2 at the maximum-diameter portion 52. Thus, the amount of engine oil supplied from the crank chamber 30 upward beyond the maximum-diameter portion 52 when the piston 18 is at the bottom dead center can be reduced.

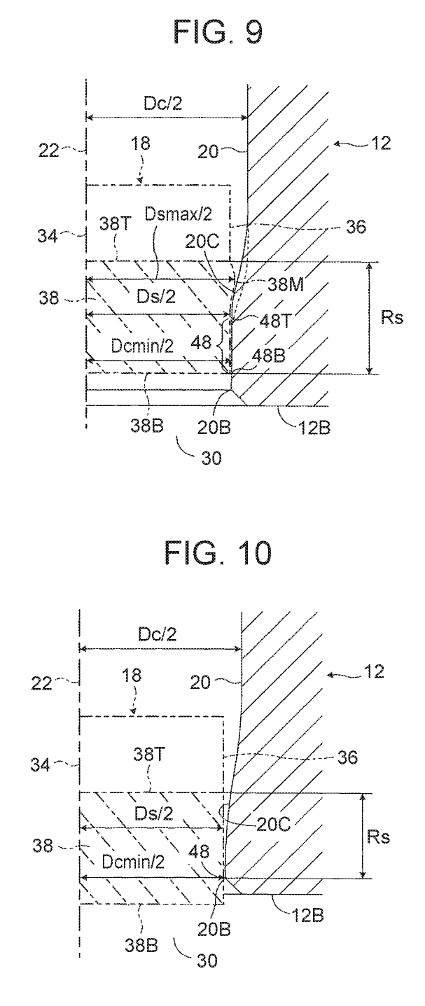

In the fourth embodiment shown in FIG. 9, the diameter Ds of the skirt 38 of the piston 18 is maximum at a ridge 38M in the vicinity of the upper end 38T, and the ridge 38M extends in an arc shape around the axis 34 of the piston 18. A maximum diameter of the ridge 38M is Dsmax, and the diameter Ds in a region on the side of the lower end 38B from the ridge 38M is substantially constant.

The minimum-diameter portion 48 of the cylinder bore 20 is ranges from a position facing an intermediate portion of the skirt 38 between the ridge 38M and the lower end 38B when the piston 18 is at the bottom dead center, to the lower end 20B of the cylinder bore 20. Thus, the clearance in the radial direction between the skirt 38 and the wall surface of the cylinder bore 20, (Dc−Ds)/2, is minimum in this range corresponding to the minimum-diameter portion 48 at (Dcmin−Ds)/2.

In the embodiment shown in FIG. 9, the curved surface 20C extends parallel to at least a part of an inclined surface on the lower side of the ridge 38M so that the interval between the ridge 38M and the curved surface 20C is substantially equal to the minimum clearance (Dcmin−Ds)/2. Alternatively, the curved surface 20C may be disposed at a distance from the inclined surface on the lower side of the ridge 38M as indicated by the dashed line in FIG. 9. The configuration of the fourth embodiment is otherwise the same as that of the second embodiment.

According to the fourth embodiment, in the internal combustion engine 10 in which the skirt 38 of the piston 18 has the ridge 38M in the vicinity of the upper end 38T, the clearance between the skirt 38 and the wall surface of the cylinder bore 20, (Dc−Ds)/2, can be minimized to the minimum value (Dcmin−Dsmax)/2 downward from the ridge 38M. Thus, the amount of engine oil supplied from the crank chamber 30 upward beyond the region with the minimum value of the clearance (Dcmin−Dsmax)/2 when the piston 18 is at the bottom dead center can be reduced.

In the fifth embodiment shown in FIG. 10, when the piston 18 is at the bottom dead center, the lower end 38B of the skirt 38 that has a columnar shape as in the first embodiment is located farther on the lower side than the lower end 20B of the cylinder bore 20, so that the lower end of the skirt 38 protrudes downward from the cylinder bore 20. Thus, when the piston 18 is at the bottom dead center, the range Rs of the skirt 38 from the upper end 38T to the position corresponding to the lower end 20B of the cylinder bore 20 faces the wall surface of the cylinder bore 20, and the region of the skirt 38 downward from the range Rs is exposed to the crank chamber 30.

At least in the region facing the piston 18 at the bottom dead center, the diameter Dc of the cylinder bore 20 is smaller toward the lower end 20B of the cylinder bore 20. Accordingly, the minimum-diameter portion 48 is the lower end 20B of the cylinder bore 20, and the minimum diameter is Dcmin. Moreover, the clearance in the radial direction between the skirt 38 and the wall surface of the cylinder bore 20, (Dc−Ds)/2, is minimum at the lower end 20B at (Dcmin−Ds)/2. The configuration of the fifth embodiment is otherwise the same as that of the first embodiment.

The structure of the fifth embodiment is the same as the structure of the first embodiment, except that the lower end of the skirt 38 protrudes downward from the cylinder bore 20 when the piston 18 is at the bottom dead center. According to the fifth embodiment, therefore, the same advantages as in the first embodiment can be achieved in the internal combustion engine 10 in which the lower end of the skirt 38 protrudes downward from the cylinder bore 20 when the piston 18 is at the bottom dead center.

Moreover, the lower end 20B of the cylinder bore 20 has the minimum-diameter portion 48, and the clearance between the skirt 38 and the wall surface of the cylinder bore 20 has the minimum value (Dcmin−Ds)/2 at this lower end. Thus, engine oil adhering to a radially outer surface of the portion of the skirt 38 exposed to the crank chamber 30 can be scraped off by the lower end 20B when the piston 18 moves from the bottom dead center toward the top dead center.

According to the above embodiments, when seen in a section passing through the axis 22, the wall surface of the cylinder bore 20 has the curved surface 20C convex toward the axis 22 in the region adjacent to the minimum-diameter portion 48 and located closer to the upper end 12T than the minimum-diameter portion 48 is. Accordingly, compared with if the wall surface of the cylinder bore 20 has a conical shape or a curved surface convex in a direction away from the axis 22 (e.g., see the dashed line in FIG. 5), the clearance between the skirt 38 and the wall surface of the cylinder bore 20 on the upper side of the minimum-diameter portion 48 can be reduced. Thus, the amount of engine oil present between the skirt 38 and the wall surface of the cylinder bore 20 in the region adjacent to the minimum-diameter portion 48 and located on the upper side of the minimum-diameter portion can be reduced.

Moreover, compared with if the wall surface of the cylinder bore 20 has a conical shape or a curved surface convex in a direction away from the axis, the clearance between the lower end 38B of the skirt 38 and the wall surface of the cylinder bore 20, (Dc−Ds)/2, when the piston 18 moves off the bottom dead center toward the top dead center can be reduced. Thus, the amount of engine oil supplied from the crank chamber 30 to the clearance between the skirt 38 and the wall surface of the cylinder bore 20 when the piston 18 moves off the bottom dead center toward the top dead center can be reduced.

According to the above embodiments, the diameter Dc of the cylinder bore 20 in the region facing the skirt 38 when the piston 18 is at the top dead center is smaller toward the upper end 12T of the cylinder block 12. Accordingly, the interval between the compression rings and the wall surface of the cylinder bore 20 becomes smaller and a gas flow path becomes narrower as the piston 18 comes closer to the top dead center. Thus, the amount of blow-by gas generated when the piston 18 is at or in the vicinity of the top dead center can be reduced. Moreover, it is possible to reduce the likelihood that friction between the skirt and the wall surface of the cylinder bore increases due to the engine oil present between the skirt 38 and the wall surface of the cylinder bore 20 being moved by the blow-by gas toward the crank chamber.

Moreover, according to the second and fourth embodiments, the region where the clearance in the radial direction between the skirt 38 and the wall surface of the cylinder bore 20, (Dc−Ds)/2, has the minimum value (Dcmin−Ds)/2 not only extends along the axis 22 but also reaches the lower end 20B of the cylinder bore 20. Accordingly, compared with if the clearance (Dc−Ds)/2 at the lower end 20B is larger than the minimum value as in the third embodiment, the amount of engine oil adhering to the radially outer surface of the skirt 38 when the piston 18 is at the bottom dead center can be reduced. Thus, the amount of engine oil moving upward by adhering to the surface of the skirt 38 during a compression stroke of the piston 18 can be effectively reduced.

Moreover, according to the second to fourth embodiments, the range in the axial direction of the cylindrical region having the constant diameter Dmin and extending along the axis 22 is smaller than the range Rs in which the skirt 38 faces the wall surface of the cylinder bore 20. Thus, compared with if the range in the axial direction of the cylindrical region having the constant diameter Dmin and extending along the axis 22 is equal to or larger than the range Rs, friction between the skirt 38 and the wall surface of the cylinder bore 20 can be reduced, and friction loss can be reduced accordingly.

The specific embodiments of the present disclosure have been described in detail above. However, it would be clear to those skilled in the art that the present disclosure is not limited to the above embodiments but can be implemented in various embodiments within the scope of the disclosure.

For example, in the first to fourth embodiments, the lower end 38B of the skirt 38 is located slightly above the lower end 20B of the cylinder bore 20 when the piston 18 is at the bottom dead center. However, the lower end 38B of the skirt 38 may be located at the same axial position as the lower end 20B of the cylinder bore 20 when the piston 18 is at the bottom dead center.

The second to fourth embodiments may be modified so that, as in the fifth embodiment, the lower end 38B of the skirt 38 is located at an axial position below the lower end 20B of the cylinder bore 20 when the piston 18 is at the bottom dead center.

The first or fifth embodiment may be modified so that the skirt 38 has a barrel shape as in the third embodiment or has a ridge as in the fourth embodiment, instead of forming the arc-shaped plate.

In the above embodiments, the wall surface of the cylinder bore 20 has the curved surface 20C convex toward the axis 22 in the region adjacent to the minimum-diameter portion 48 and located on the upper side of the minimum-diameter portion 48. However, as indicated by the dashed line in FIG. 5, the wall surface of the cylinder bore 20 may has a curved surface convex in a direction away from the axis 22 in this region, or has a conical surface with a constant inclination angle relative to the axis 22.

In the second and fourth embodiments, the minimum-diameter portion 48 ranges from a position facing an intermediate portion of the skirt 38 between the upper end 38T and the lower end 38B to the lower end 20B of the cylinder bore 20. However, the second or fourth embodiment may be modified so that the diameter at the lower end 20B and at a region in the vicinity of the lower end 20B is larger than the minimum diameter Dcmin.

In the above embodiments, the diameter Dc of the cylinder bore 20 is constant in the region on the upper side of the upper end 38T of the skirt 38 when the piston 18 is at the top dead center, and this region is a region at the upper-end small-diameter portion 50 of the cylinder bore 20. However, these embodiments may be modified so that the lower end of the upper-end small-diameter portion 50 is located farther on the lower side than the upper end 38T of the skirt 38 when the piston 18 is at the top dead center. Moreover, the upper end of the cylinder bore 20 may have another shape instead of the shape shown in the above embodiments.

What is claimed is:

1. An internal combustion engine comprising:
a cylinder block having at least one cylinder bore, the at least one cylinder bore extending along an axis of the cylinder bore;
a cylinder head fixed to a first end of the cylinder block with a plurality of bolts; and
a piston configured to reciprocate along the axis, the piston being housed in the cylinder bore, the piston including a skirt capable of sliding along a wall surface of the cylinder bore, wherein
the cylinder bore includes a first portion within a first range,
the first portion is a portion at which a diameter of the cylinder bore is minimum in a second range of the cylinder bore,
the second range is a range across which the skirt travels as the piston reciprocates,
the first range is a range in an axial direction of the cylinder bore facing the skirt when the piston is at a bottom dead center, and
a clearance in a radial direction of the cylinder bore between the skirt and the first portion when the piston is located at the bottom dead center has a minimum value of a clearance in the radial direction between the skirt and the wall surface of the cylinder bore in the second range.

2. The internal combustion engine according to claim 1, wherein
the cylinder block includes the first end and a second end,
the skirt includes a third end and a fourth end,
the third end is an end of the skirt located closer to the first end of the cylinder block when the piston is located at the bottom dead center,
the fourth end is an end of the skirt located farther from the first end of the cylinder block when the piston is located at the bottom dead center,
when the piston is at the bottom dead center, the fourth end is located at one of a position at the same position in the axial direction as the second end and a position closer to the first end than the same position as the second end, and
when the piston is at the bottom dead center, the first portion is located closer to the second end of the cylinder block than the third end is.

3. The internal combustion engine according to claim 2, wherein the first portion is located at a position facing the fourth end of the skirt when the piston is at the bottom dead center.

4. The internal combustion engine according to claim 1, wherein
the cylinder block includes the first end and a second end,
the skirt includes a third end and a fourth end,
the cylinder bore includes a fifth end,
the fifth end is an end of the cylinder bore located closer to the second end of the cylinder block,
the fourth end of the skirt when the piston is at the bottom dead center is located on an opposite side of the fifth end from the first end, and
the fifth end of the cylinder bore is a part of the first portion.

5. The internal combustion engine according to claim 1, wherein
when seen in a section in a radial direction passing through the axis, the wall surface of the cylinder bore has a curved surface adjacent to the first portion and located closer to the first end than the first portion is,
the curved surface is more convex toward the axis than a conical surface connecting the first portion and a second portion to each other,
the second portion is located closer to the first end than the first portion is in the cylinder bore, and
the second portion has a diameter larger than a minimum diameter.

6. The internal combustion engine according to claim 1, wherein
the first portion has a constant diameter, and
the first portion is a portion in a cylindrical region of the cylinder bore extending along the axis in the cylinder bore.

7. The internal combustion engine according to claim 1, wherein a diameter of a part of the cylinder bore facing the skirt when the piston is at a top dead center is smaller toward the first end.
